(19) United States
(12) Patent Application Publication
(10) Pub. No.: US 2020/0069403 A1
(43) Pub. Date: Mar. 5, 2020

(54) ELECTRIC TOOTHBRUSHING SYSTEM

(71) Applicant: BRUSHETTE, INC., Burbank, CA (US)

(72) Inventor: Mihran Papazian, Granada Hills, CA (US)

(21) Appl. No.: 16/614,366

(22) PCT Filed: May 17, 2018
(86) PCT No.: PCT/US2018/033068

§ 371 Date: Nov. 17, 2019

Related U.S. Application Data
(60) Provisional application No. 62/507,787, filed on May 18, 2017.

(51) Int. Cl. A61C 17/22; A46B 5/00; A46B 7/04; A46B 13/02; A46B 15/00

(52) U.S. Cl. CPC A61C 17/221; A46B 5/0095; A46B 2200/1066; A46B 13/023; A46B 15/0002; A46B 7/04

(57) ABSTRACT

An electric toothbrush system may include a brush head, an adapter, and a personal computing device. The brush head may have a plurality of bristles. The adapter may include an actuator, a stem extending from the actuator, and a connector electrically connected to the actuator. The personal computing device may contain a power source. The stem may be configured to couple with the brush head, and the actuator may be configured to receive power from the personal computing device through the connector and actuate the brush head via the stem.

### CROSS REFERENCE TO RELATED APPLICATION

This application is a national stage filing under 35 U.S.C. § 371 of International Application No. PCT/US2018/033068, filed May 17, 2018, which claims the benefit of and priority to U.S. Provisional Application Ser. No. 62/507,787, filed May 18, 2017, the contents of which are incorporated by reference herein in their entireties.

### FIELD OF THE INVENTION

The field of the invention relates to tooth brushing systems, specifically a system that includes an adapter for connecting brush heads to a personal computing device.

### BACKGROUND OF THE INVENTION

Electric toothbrushes offer several known advantages with respect to maintaining good dental hygiene. Several electric toothbrush systems are presently available and these systems generally include a replaceable head that is attached to a main body that provides a handle for the toothbrush and houses the electro-mechanical components, controller, and power source. The brush head is typically a single disposable piece having a neck and bristle portion that is attached to the handle.

Present systems include several drawbacks. For example, the main body that houses the electro-mechanical and power components can be heavy and require a special charging station. The user must remember to charge the battery within the electric toothbrush handle. Also, the electric toothbrush systems and charging stations take up luggage space when travelling and occupies bathroom counter-space and is therefore inconvenient for the user.

Thus, there is a need for improved electric toothbrushing systems.

### SUMMARY OF THE INVENTION

It is an aspect of the various embodiments of the present invention to provide an electric toothbrush system comprising a brush head, an adapter, and a personal computing device. The brush head may have a plurality of bristles. The adapter may comprise an actuator, a stem extending from the actuator, and a connector electrically connected to the actuator. The personal computing device may contain a power source. The stem may be configured to couple with the brush head, and the actuator may be configured to receive power from the personal computing device through the connector and actuate the brush head via the stem.

These and other aspects of the present invention will be apparent in view of the following description.

### BRIEF DESCRIPTION OF THE DRAWINGS

The drawing Figures depict one or more implementations in accord with the present concepts, by way of example only, not by way of limitations. In the figures, like reference numerals refer to the same or similar elements.

FIG. 1 is an exploded view of an electric toothbrushing system according to one embodiment of the present invention.

FIG. 2 is a front elevational view of a brush head assembly according to another embodiment of the present invention.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details.

Generally, the various embodiments of the present invention provide an electric toothbrushing system that enables the typical handle to be replaced with an adapter that may be plugged into a personal computing device, such as a smart phone. A standard replaceable toothbrush head may be releasably coupled to the adapter and an electronic cable having a connector may extend from the adapter to be electrically connected to the personal computing device. As used herein throughout the specification and the claims, “releasably coupled” with respect to a component of the assembly means configured to be repeatedly attached and separated without destroying the component. Various embodiments of the present invention provide a system in which the brush portion may be periodically replaced.

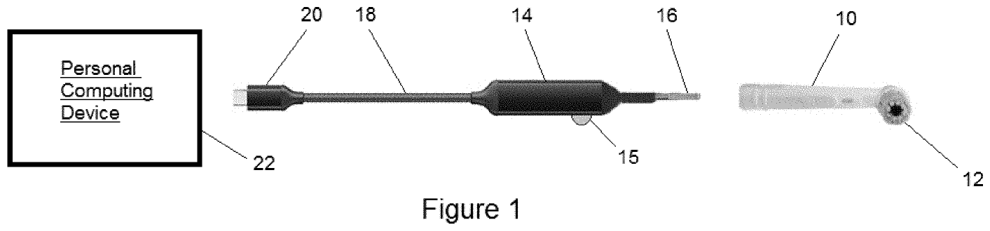

Referring now to FIG. 1, a first embodiment of the present invention is illustrated. The toothbrushing system may comprise a replaceable brush head. The brush head comprises a neck 10 and a plurality of bristles 12 that preferably extend from a distal end of the neck 10. The replaceable brush head may be any type known to those of skill in the art, like the replaceable brush heads manufactured by Oral-B, Philips, or Panasonic. The replaceable brush head may be a single piece with no moving parts, such as those used in sonicating type electric toothbrushes, or the replaceable brush head may be an assembly in which a portion bearing the bristles is able to rotate relative to the neck portion of the brush head. The opposite side of the distal end of the neck 10 may include other optional features, such as a tongue scraper.

The brush head may be provided with a variety of bristle configurations to vary the bristle pattern and degree of stiffness. For example, the bristles may be configured to have a soft, medium, or hard stiffness, depending on the combination of bristle thickness and location about the main body of the head. The material used for the bristles may also be varied depending on the desired degree of stiffness. Examples of materials that may be used to manufacture the bristles include, but are not limited to, nylon, silk, and silicon. This would allow a user to temporarily switch to a softer brush, if the user was experiencing sensitive gums, for example.

The proximal end of the neck 10 may be configured to couple to the stem 16 of an adapter 14. For example, the proximal end of the neck 10 may include a female portion similar to those known by those skilled in the art in order to receive the stem 16. In other embodiments, the stem 16 may be replaced with a female receptacle and the neck 10 of the brush head provided with the male portion to couple with the adapter 14.

Various means may be employed to secure the brush head to the stem. For example, in one embodiment, the stem may include threading around the outer surface of the stem and a corresponding threading may be provided within the female receptable of brush head, so that the brush head may be screwed onto the stem. So that the brush head does not rotate during operation, a locking portion may be provided on one of the brush head or the stem, such as a snap, to maintain the neck of the brush head in a fixed position relative to the stem. In order to separate the brush head from the stem, the locking portion may be made of a resilient material, so that it may be unsnapped prior to screwing the brush head off of the stem.

In another embodiment, the locking portion may be configured similar to a child resistant cap. For example, the neck of the brush head may be designed, such that the brush head must be depressed towards the adapter while screwing the brush head onto and off of the stem. Alternatively, the brush head and stem may be provided with indicia that must be lined up in order to releasably couple the brush head to the stem. In another embodiment, the neck portion of the assembly may be eliminated by forming the stem on the adapter into the shape of a neck portion having a receptacle to receive a head portion carrying the bristles, similar to the brush head assembly disclosed in International Application Publication WO 2018/085484, the contents of which are incorporated by reference herein.

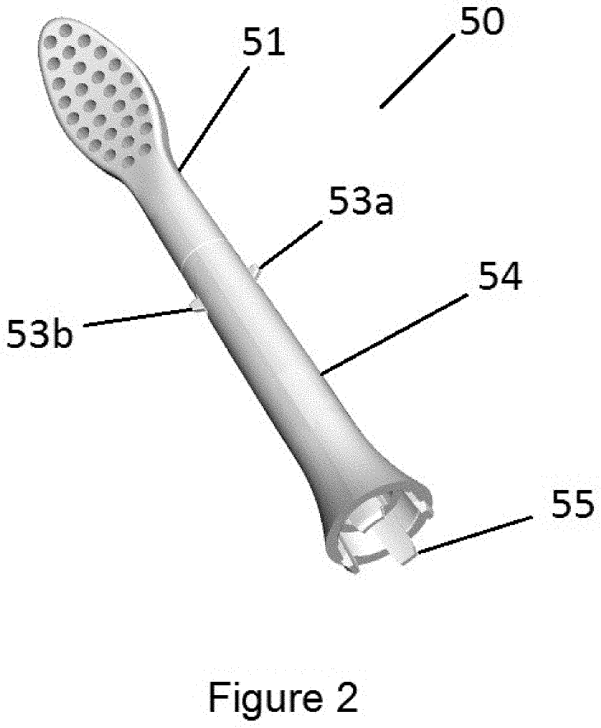

Other examples of locking devices include a pressure button system, a press-fit system, and detents. For example, referring to FIG. 2, a two-part brush head is illustrated. The two-part assembly 50 may comprise a head portion 51 and neck portion 54. The neck portion 54 may include a plurality of connectors 55 at the base of the neck portion 54 for attaching the assembly to the adapter. For example, the adapter may provide a seat for the assembly 50 comprising a plurality of corresponding holes to receive the connectors 55. The connectors may be resilient to allow a user to detach the brush head from the adapter. The opposite end of the neck portion 54 may be open to receive the head portion 51 of the assembly 50. The head portion 51 illustrated without bristles may be releasably attached to an end of the stem 54 by using one or more resilient detents 53a, 53b, for example. The detents 53a, 53b may be provided with an angled leading surface, such that when the head 51 is inserted into the open end of the stem 54, the detents 53a, 53b are deflected. However, when the detents 53, 53b reach corresponding holes in the wall of the stem 54, the detents 53a, 53b relax and capture the head 51 onto the stem 54. In order to release the head 51 from the stem 54, the detents 53a, 53b are depressed while simultaneously pulling the head 51 away from the stem 54. In another embodiment, the stem of the adapter may be designed to receive the head portion 51 with corresponding holes, similar to the neck portion 54, so that the head portion 51 may be releasably attached directly to the stem, which would eliminate the need for neck portion 54. In another embodiment, the assembly 50 may be a single piece instead of a two-part assembly, thereby eliminating the detents 53a, 53b.

The adapter 14 houses the electro-mechanical components that form an actuator for actuating the brush head via the stem 16. For example, the actuator may cause the stem 16 to ultrasonically vibrate, if the brush head is a sonicating type brush head. Alternatively, if the brush head is an oscillating type brush, the actuator may be in the form of a motor, and mechanical motion from the motor may be imparted onto the stem 16, such that the stem 16 rotationally oscillates about a longitudinal axis that extends through the length of the stem 16. The stem 16 may be operably connected to the bristles 12 of the brush head, such that the rotation of the stem 16 translates to rotation of the bristles 12. The rotational axis of the bristles 12 therefore would be generally perpendicular to the rotational axis of the stem 16. Thus, the stem 16 may be configured to accommodate various types of brush heads, including the brush heads disclosed in previously cited WO 2018/085484.

As previously explained, the housing of the adapter 14 does not need to house a power source or a controller. Therefore, the adapter 14 may be compact and lightweight when compared to the handle of most standard electric toothbrushes. The length and contours of the housing may be ergonomically designed to allow for easy grip by the user. The adapter 14 may also optionally include a manual switch 15 for selectively turning the actuator on and off.

In order to provide power to the actuator within the housing of the adapter 14, the adapter 14 may further comprise a connector 20 electrically connected to the actuator via a cable 18, and the connector 20 may be configured to plug into a personal computing device 22. The personal computing device may be a desktop computer, laptop, smartphone, or tablet. Due to their portability, it is preferred that the personal computing device is a smartphone. Depending on the type of personal computing device included in the systems made according to the various embodiments of the invention, the connector 20 should be selected that is compatible with the personal computing device. The connector 20 should be configured to allow for the transfer of both power from a power source within the portable computing device 22, as well as control signals from a controller within the personal computing device 22. The connector 20 may be, for example, a USB connector (e.g. USB 2.0 Type A, 2.0 Type B, 2.0 Micro B, 2.0 Mini, 2.0 Mini-B, 3.0 A, 3.0 B, 3.0 Micro-B, 3.0 Type C, etc.).

In order to control the actuator within the adapter 14, the adapter 14 may be connected to the personal computing device 22 via the connector 20 and cable 18, and an application may be loaded onto the personal computing device 22. For example, the application may allow for the control of power to the actuator to selectively turn the actuator on and off. The application may also include a timing program, so that a user may set a time period for the actuator to automatically turn off after operating for the selected period.

The application may also allow for keeping a hygiene log in order to collect the user's information. Examples of data that may be collected by the application include brushing frequency, length of time of each brushing, brushing speed, type of brush head used, and force applied to the brush during brushing. If the personal computing device has a camera, the application may use the camera and recognition software to monitor the brushing and map the areas of the mouth that were properly brushed. All of the collected data may provide insight into the brushing habits of the user. This information may be analyzed by the application to provide recommendations to the user by displaying the analysis on the personal computing device and potentially improve oral hygiene. Because the various embodiments of the invention may rely on the personal computing device to operate the brush head, this ensures that data is collected every time the system is used. This differs from passive mobile applications that collect the brushing habits of users only when the user remembers to turn on the application during brushing. Therefore, various embodiments of the present invention may be capable of collecting more data than present systems. The incorporation of artificial intelligence may also allow customization of the user experience. For example, the application may be permitted access to a user's calendar that is also stored on the personal computing device to suggest the use of a teeth whitener a few days in advance of an upcoming social event.

The systems according to the various embodiments of the invention may also optionally include safety features, such as an indicator for informing the user as to whether the brush head is adequately attached to the stem. This may prevent potential injury, if the brush head were to become loose during the act of brushing. In one embodiment, the indicator may be in the form of a lighting system that uses power from the personal computing device to provide forward voltage (V_{F}) to a diode disposed on the brush head or in between bristles. The brush head and stem may be configured, such that the light will not illuminate unless the brush head is seated correctly. The illuminated bristles may also improve the aesthetic appearance of the toothbrush assembly. The light may also be controlled by the personal computing device and serve as an indicator to alert the user of either the need to recharge the battery or that the brush head should be replaced due to length of use, for example.

The adapter in the assemblies according to the present invention provide a simplified design that potentially eliminates electronic waste by relying on the personal computing device as the power source and controller for the system. The components of the assemblies according to the present invention may be made from any material known by those of skill in the art that are used in the fabrication of brush heads and electric toothbrushes. The materials used are preferably selected from plastic and/or metals that are safe for use for oral hygiene applications and may also deter the growth of bacteria. Examples of materials that may be incorporated in the components of the assemblies according to the various embodiments of the present invention include, but are not limited to, titanium, zirconia, gold, and carbon. Antibacterial/antimicrobial compounds may also be incorporated into the materials.

While particular embodiments of the present invention have been illustrated and described, it would be obvious to those skilled in the art that various other changes and modifications can be made without departing from the spirit and scope of the invention.

I claim:

1. An electric toothbrush system comprising:
a brush head having a plurality of bristles;
an adapter comprising an actuator, a stem extending from the actuator, and a connector electrically connected to the actuator; and
a personal computing device containing a power source and a controller,
wherein the stem is configured to couple with the brush head, and
wherein the actuator is configured to receive power and control signals from the personal computing device through the connector and actuate the brush head via the stem.

2. The electric toothbrush system of claim 1, wherein at least a portion of the brush head is rotatable.

3. The electric toothbrush system of claim 1, wherein the adapter is configured to vibrate the brush head.

4. The electric toothbrush system of claim 1, wherein the personal computing device is selected from the group consisting of desktop computers, laptops, smartphones, and tablets.

5. The electric toothbrush system of claim 1, wherein the personal computing device is a smartphone.

6. The electric toothbrush system of claim 1, wherein at least one of the adapter and the brush head further comprises a locking portion configured to retain the brush head to the adapter.

7. The electric toothbrush system of claim 6, wherein the locking portion comprises a resilient detent configured to releasably couple the brush head to the adapter in an assembled condition.

8. The electric toothbrush system of claim 1, wherein the brush head further comprises a neck having a distal end and a proximal end, and the plurality of bristles extend from a distal end of the neck.

9. The electric toothbrush system of claim 9, wherein the stem and neck are configured to releasably couple the proximal end of the neck to the adapter in an assembled condition.

10. The electric toothbrush system of claim 1, wherein the connector comprises a USB connector.

11. The electric toothbrush system of claim 1, wherein the adapter further comprises a switch configured to selectively connect and disconnect the actuator from the power source.

12. The electric toothbrush system of claim 1, wherein the personal computing device further comprises a controller configured to operate the actuator.

13. The electric toothbrush system of claim 1, wherein the adapter further comprises a cable connecting the actuator and the connector.
